(19) United States
(12) Patent Application Publication
(10) Pub. No.: US 2011/0237468 A1
(43) Pub. Date: Sep. 29, 2011

(54) METHODS FOR BLOCKING UNDERGROUND FORMATIONS

(76) Inventors: Roland Reichenbach-Klinke, Traunstein (DE); Marcus Guzmann, Muhlhausen (DE); Thomas Pfeuffer, Hassfurt (Sylbach) (DE); Gregor Herth, Trostberg (DE); Stefan Friedrich, Garching (DE)

(21) Appl. No.: 12/733,370

(22) PCT Filed: Nov. 7, 2009
(86) PCT No.: PCT/EP2009/009358

§ 371 Date: Apr. 19, 2011

(30) Foreign Application Priority Data
Dec. 18, 2008 (EP) 08172049.2

(51) Int. Cl. C09K 8/588

(52) U.S. Cl. 507/226; 507/219; 507/221; 507/227; 507/224; 507/225

(57) ABSTRACT

A process is proposed for blocking underground formations in the extraction of fossil oil and/or gas, a first step involving introducing water-absorbing particles into liquid-bearing and porous rock formations, said particles being water-swellable, crosslinked and water-insoluble polymers, said particles in the water-bearing rock formation finally preventing liquid flow through the rock layers by water absorption. This process is characterized in that the absorbing particles comprise a superabsorbent polymer with anionic and/or cationic properties and a retarded swelling action. This process, which can also be carried out in saline formation waters, is notable in that the swelling of the superabsorbents used begins no earlier than after five minutes and in that the superabsorbents are obtainable by four proposed process variants and any combination thereof. This process, which does not need a carrier liquid, is notable for its simplicity and especially the controllable retardation of the swelling action under the specific conditions of underground rock formations.

The present invention provides a process for blocking underground formations during the production of fossil oil and/or gas.

In the production and extraction of liquid or else gaseous hydrocarbons from underground formations, the greatly varying porosities of the underground rock formations, especially in the presence of fissured rock formations, which are referred to as “fractured reservoirs”, can cause problems.

Frequently, in the course of so-called secondary or tertiary oil production measures, water, steam or aqueous polymer solutions are pumped into the formation, in order thus to force the hydrocarbons out of the formations and the fissures present therein. In the case of these measures, differences in the porosities of the formation lead to the effect that the particular flooding medium preferentially flows through the permeable channels, such that zones of lower porosity are flooded only incompletely, if at all. As a result, exclusively those hydrocarbons which are within the more permeable rock regions then become accessible and extractable.

In order to prevent this, attempts are therefore made to block the more permeable channels selectively, for which, for example, water-swellable polymer particles which are also referred to as superabsorbents or superabsorbent polymers (SAPs) are used (cf. U.S. Pat. No. 4,182,417).

Superabsorbent polymers are crosslinked, high molecular weight, either anionic or cationic polyelectrolytes which are obtainable by free-radical polymerization of suitable ethylenically unsaturated vinyl compounds and subsequent measures for drying the resulting copolymers. On contact with water or aqueous systems, a hydrogel forms with swelling and water absorption, in which case several times the weight of the powdery copolymer can be absorbed. Hydrogels are understood to mean water-containing gels based on hydrophilic but crosslinked water-insoluble polymers which are present in the form of three-dimensional networks.

Superabsorbent polymers are thus generally crosslinked polyelectrolytes, for example consisting of partly neutralized polyacrylic acid. They are described in detail in the book “Modern Superabsorbent Polymer Technology” (F. L. Buchholz and A. T. Graham, Wiley-VCH, 1998). In addition, more recent patent literature includes a multitude of patents which are concerned with superabsorbent polymers.

Reference is made here by way of example to the following documents:

U.S. Pat. No. 5,837,789 describes a crosslinked polymer which is used for absorption of aqueous liquids. This polymer is formed from partly neutralized monomers with monoethylenically unsaturated acid groups and optionally further monomers which are copolymerized with the first component groups. A process for preparing these polymers is also described, wherein the particular starting components are first polymerized to a hydrogel with the aid of solution or suspension polymerization. The polymer thus obtained can subsequently be crosslinked on its surface, which should preferably be done at elevated temperatures.

Gel particles with superabsorbent properties, which are composed of several components, are described in U.S. Pat. No. 6,603,056 B2. The gel particles comprise at least one resin which is capable of absorbing acidic, aqueous solutions, and at least one resin which can absorb basic, aqueous solutions. Each particle also comprises at least one microdomain of the acidic resin, which is in direct contact with a microdomain of the basic resin. The superabsorbent polymer thus obtained is notable for a defined conductivity in salt solutions, and also for a defined absorption capacity under pressure conditions.

The emphasis of EP 1 393 757 B1 is on absorbent cores for nappies with reduced thickness. The absorbent cores for capturing body fluids comprise particles which are capable of forming superabsorbent cores. Some of the particles are provided with surface crosslinking in order to impart an individual stability to the particles, so as to give rise to a defined salt flow conductivity. The surface layer is bonded essentially noncovalently to the particles and it contains a partly hydrolysable, cationic polymer which is hydrolysed within the range from 40 to 80%. This layer has to be applied to the particles in an amount of less than 10% by weight. The partly hydrolysed polymer is preferably a variant based on N-vinylalkylamide or N-vinylalkylimide, and especially on N-vinylformamide.

Superabsorbent hydrogels coated with crosslinked polyamines are also described in International Patent Application WO 03/0436701 A1. The shell comprises cationic polymers which have been crosslinked by an addition reaction. The hydrogel-forming polymer thus obtainable has a residual water content of less than 10% by weight.

A water-absorbing polymer structure surface-treated with polycations is described in German Offenlegungsschrift DE 10 2005 018 922 A1. This polymer structure, which has also been contacted with at least one anion, has an absorption under a pressure of 50 g/m² of at least 16 g/g.

Superabsorbent polymers coated with a polyamine are the subject matter of WO 2006/082188 A1. Such superabsorbent polymer particles are based on a polymer with a pH of >6. The hygiene articles which have also been described in this connection exhibit a fast absorption rate with respect to body fluids.

Superabsorbent polymer particles coated with polyamines are also disclosed by WO 2006/082189 A1. A typical polyamine compound mentioned here is polyammonium carbonate. In this case too, the fast absorption of body fluids by the particles is at the forefront.

A typical preparation process for polymers and copolymers of water-soluble monomers and especially of acrylic acid and methacrylic acid is disclosed in U.S. Pat. No. 4,857,610. Aqueous solutions of the particular monomers which contain polymerizable double bonds are subjected at temperatures between −10 and 120° C. to a polymerization reaction so as to give rise to a polymer layer of thickness at least one centimetre. These polymers obtainable in this way also possess fast superabsorbent properties.

Both the superabsorbent polymers described in Buchholz and those described in later patent applications are so-called “rapid” products, i.e. they attain their full water absorption capacity within a few minutes. In the case of use in hygiene articles in particular, it is necessary that liquids are absorbed as rapidly as possible in order to prevent them from running out of the hygiene article.

For the application for selective blocking of underground formations in the production of oil and/or gas, this rapid swelling, however, presents problems, since the SAP first has to be introduced over relatively long distances at its site of action, the underground formation.

International Patent Application WO96/02608 A1 solves this problem by dispersing the sulphonated superabsorbent based on 2-acrylamido-2-methylpropanesulphonic acid (AMPS) in hydrocarbons. This measure ensures that the superabsorbent swells only when it comes into contact with water at its site of use.

US 2004/0168798 also describes the use of superabsorbents in the field of use already addressed. According to this publication, crosslinked polyacrylamides are used as superabsorbents. Here, too, the superabsorbent is transported for use in the formation by using a nonaqueous medium as a carrier fluid. A solution of CaCl₂ is also said to be suitable as a carrier medium. Depending on the concentration of the salt solution, the swelling of the superabsorbent can be retarded: this means that the higher the concentration of CaCl₂ in the carrier liquid, the longer the complete swelling of a superabsorbent takes. However, a disadvantage of this proposed process is that this delays only the end point of the swelling, but not the commencement of swelling.

Additionally, in U.S. Pat. No. 5,701,955 there is discussed a method for the reduction of permeability over water comprising the insertion of a dispersion of water swellable polymer particles with a particle size <10 μm in a non-aqueous solvent.

The use of very small particle sizes is also disclosed by U.S. Pat. No. 5,735,349. The particles of the superabsorbent show sizes of from 0.05 to 1 μm and are also used as a dispersion in a non-aqueous solvent.

In contrast, US 2003/149212 discloses a superabsorbent with a retarded swelling containing besides usual used stable crosslinkers additionally instable cross linkers. These stable crosslinkers may hydrolize in the formation at higher temperatures and thereby allow the swelling of the particles. The disclosure of this document is limited to particle sizes of from 0.05 to 10 μm. This limitation restricts significantly possible application forms of such systems.

A similar system is discussed by WO 2007/126318. Also in this document there is disclosed a combination of stable and instable crosslinkers. An important aspect of this system is the production of the particles in an oil-in-oil emulsion.

Another alternative for the retardation of the swelling of superabsorbents is disclosed by US 2008/108524. In this case the superabsorbent is coated with a shell of a water soluble polymer. This shell in a first step hinders the swelling of the superabsorbent and in an additional step is disintegrating in such that a swelling is possible.

One approach to a solution can thus be considered in each case to be that of using suitable superabsorbents. Superabsorbents with retarded swelling are described in the priority application DE 10 2008 030 712.2 which was yet to be published at the priority date of the present application.

Due to the shortcomings in connection with the production of oil and/or gas which have been outlined at the start, the present invention has for its object to provide a novel process for blocking underground formations in the production of fossil oil and/or gas, a first step involving introducing water-absorbing particles into liquid-bearing and porous rock formations, said particles being water-swellable, crosslinked and water-insoluble polymers and these particles in the water-bearing rock formation finally preventing liquid flow through the rock layers by water absorption. The novel process should be very easy to perform and not need any carrier liquids. At the same time, it must be ensured that the permeable channels are blocked sufficiently selectively that the flooding medium selected reaches all rock areas from which the hydrocarbons are to be extracted.

This object is achieved with the aid of the process according to the invention, in which the absorbing particles comprise a superabsorbent polymer (SAP) with anionic and/or cationic properties and a retarded swelling action.

It has been found that, surprisingly, this process—which preferably does not need any nonaqueous carrier liquid—and in particular the use of the specific absorbing particles does not just completely satisfy the objective, but the rheology jump already known, resulting from the absorption of liquid into the superabsorbent polymers used in accordance with the invention, is also achieved in underground formations. This was unforeseeable because the fossil reservoirs are in an environment which is characterized by high temperatures and high pressures. An additional factor is the flow behaviour in the gaps and fissures of the rock formations, which constitutes a considerable difference from the fields of use in construction chemistry in which, according to the unpublished priority application DE 10 2008 030 712.2, the superabsorbent polymers described have found use to date.

It has been found, advantageously, that superabsorbents which have been prepared by polymerizing ethylenically unsaturated vinyl compounds are particularly suitable.

It was also unexpected that the particular superabsorbents are useable in saline formation waters in the process according to the invention. The present invention therefore claims a corresponding process variant. This was all the more astonishing since it is known from the prior art that salt solutions retard the swelling of the superabsorbent, and it was therefore expected in the present case that, when the superabsorbents are used in saline formation waters, the controlled adjustment of retarded swelling is impossible.

The present invention also encompasses the possibility that the swelling of the superabsorbent begins no earlier than after five minutes and the superabsorbent has been prepared with the aid of process variants which are selected from four alternatives. These alternatives are a) polymerizing the monomer components in the presence of a combination consisting of at least one crosslinker non-hydrolysable under the conditions of the application and at least one crosslinker having a hydrolysable carbonic acid ester function under the conditions of the application; b) polymerizing at least one permanently anionic monomer and at least one cationic monomer that can release its cationic charge under the conditions of the application by a hydrolysis of the ester function and/or a deprotonation; c) coating a core polymer component with at least one further polyelectrolyte as a shell polymer; d) polymerizing of at least one, not hydrosable under the contions of the application, monomer with at least one monomer, having a hydrolysable carbonic acid ester function under the conditions of the application, in the presence of at least one crosslinker. The process variants a) to d) mentioned can be combined with one another in any number. Owing to the specific field of use, advantageous superabsorbents are in particular those which have a high water absorption capacity even at moderate to higher salt concentrations, especially high calcium ion concentrations. The expression “retarded swelling action” shall be understood in accordance with the invention to mean the fact that the swelling, i.e. the liquid absorption, of the superabsorbent begins no earlier than after 5 minutes. In accordance with the invention, “retarded” means that, in particular, the predominant portion of the swelling of the superabsorbent polymer occurs only after more than 10 minutes, preferably after more than 15 min and more preferably only after more than 30 min. Under quantitative aspects that means that the timely retarded superabsorbent during its application in a carrier liquid and during its introduction into the formation, after 5 minutes shows less than 5% and after 10 minutes less than 10% of its maximum in swelling. In connection with hygiene articles, retardation in the region of a few seconds has already been known for a long time, in order that, for example, the liquid is first distributed within the nappy before it is absorbed, in order to be able to exploit the entire amount of superabsorbent in the nappy and to need a smaller amount of nonwoven material. In the present case of the invention, however, retardation is understood to mean longer periods of more than 5 minutes and especially more than 10 minutes.

As already discussed, the superabsorbent polymers retarded in accordance with the invention can preferably be provided in four embodiments:

Polymerization involving a
a) combination of a first crosslinker, not hydrolysable under the conditions of its application, and of a second crosslinker, showing a hydrolysable carbonic acid ester function under the conditions of its application; or/and
b) polymerization of a permanently anionic monomer and a cationic monomer suitable for the release of its cationic charge by an ester hydrolysis and/or a deprotonation under the conditions of its application; or/and
c) coating of a superabsorbent polymer as a core with a further polyelectrolyte as a shell, the core polymer comprising non-hydrolysable crosslinkers under the conditions of its application; or/and
d) polymerization of at least one non-hydrolysable monomer with at least one monomer, showing a hydrolysable carbonic acid ester function under the conditions of its applications, in the presence of at least one crosslinker.

Each of embodiments a), b), c) or d) can be used alone. This is referred to hereinafter as “pure embodiment”. However, it is also possible to combine the inventive embodiments with one another. For instance, a polymer according to embodiment a) can be coated with a further polyelectrolyte in an additional process step according to embodiment c), in order to establish the retardation even more exactly. This is referred to hereinafter as “mixed embodiments”. What is common to all embodiments, whether pure or mixed, is that the properties of the resulting retarded superabsorbent polymer correspond to the profile of requirements. In each of the embodiments, the introduction of the inventive retarded superabsorbent polymer, for example into a construction material mixture, results in a chemical reaction which leads to an enhancement of the absorption. After the reaction, the maximum absorption is attained, which is referred to hereinafter as final absorption.

After the following features which cover all variants, first the pure embodiments will be described, before mixed embodiments are finally discussed.

The inventive SAPs are notable especially in that the particular monomer units have been used in the form of free acids, in the form of salts or in a mixed form thereof.

Irrespective of the process variant used in each case to prepare the superabsorbent, it has been found to be advantageous when the acid constituents have been neutralized after the polymerization. This is advantageously done with the aid of sodium hydroxide, potassium hydroxide, calcium hydroxide, magnesium hydroxide, sodium carbonate, potassium carbonate, calcium carbonate, magnesium carbonate, ammonia, a primary, secondary or tertiary C₁₋₂₀-alkylamine, C₁₋₂₀-alkanolamine, C₅₋₈-cycloalkylamine and/or C₆₋₁₄-arylamine, where the amines may have branched and/or unbranched alkyl groups having 1 to 8 carbon atoms. Of course, all mixtures are also suitable.

In process variants a) and/or b), the polymerization according to the present invention should have been performed especially as a free-radical bulk polymerization, solution polymerization, gel polymerization, emulsion polymerization, dispersion polymerization or suspension polymerization. Gel polymerization has been found to be particularly suitable.

It is also advisable to perform the polymerization under adiabatic conditions, in which case the reaction should preferably have been started with a redox initiator and/or a photoinitiator.

Overall, the temperature is uncritical for the preparation of the superabsorbent polymers according to the present invention. However, it has been found to be favourable not just owing to economic considerations when the polymerization has been started at temperatures between −20 and +60° C. Ranges between −10 and +50° C. and especially between 0 and 40° C. and preferably more than 30° C. have been found to be particularly suitable as start temperatures. With regard to the process pressure too, the present invention is not subject to any restriction. This is also the reason why the polymerization can ideally be performed under atmospheric pressure and, overall, without supplying any heat at all, which is considered to be an advantage of the present invention.

The use of nonaqueous solvents is essentially not required either for the polymerization reaction. However, it may be found to be favourable in specific cases when the preparation of the superabsorbent polymers has been performed in the presence of at least one water-immiscible solvent and especially in the presence of an organic solvent, In the case of the organic solvents, it should have been selected from the group of the linear aliphatic hydrocarbons and preferably n-pentane, n-hexane and n-heptane. However, branched aliphatic hydrocarbons (isoparaffins), cycloaliphatic hydrocarbons and preferably cyclohexane and decalin, or aromatic hydrocarbons, and here especially benzene, toluene and xylene, but also alcohols, ketones, carboxylic esters, nitro compounds, halogenated hydrocarbons, ethers, or any suitable mixtures thereof, are also useful. Organic solvents which form azeotropic mixtures with water are particularly suitable.

As already explained, the superabsorbent polymers according to the present invention are based on ethylenically unsaturated vinyl compounds. In this connection, the present invention envisages selecting these compounds from the group of the ethylenically unsaturated, water-soluble carboxylic acids and ethylenically unsaturated sulphonic acid monomers, and salts and derivatives thereof, and preferably acrylic acid, methacrylic acid, ethacrylic acid, α-chloroacrylic acid, β-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, itaconic acid, citraconic acid, mesaconic acid, glutaconic acid, aconitic acid, maleic acid, fumaric acid, tricarboxyethylene, maleic anhydride or any mixtures thereof.

A useful acryloyl- or methacryloylsulphonic acid is at least one representative from the group of sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid (AMPS).

Particularly suitable nonionic monomers should have been selected from the group of the water-soluble acrylamide derivatives, preferably alkyl-substituted acrylamides or aminoalkyl-substituted derivatives of acrylamide or of methacrylamide, and more preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N, N-dimethylaminopropylacrylamide, N,N-dimethylaminoethylacrylamide, N-tert-butylacrylamide, N-vinylformamide, N-vinylacetamide, acrylonitrile, methacrylonitrile, or any mixtures thereof. Further suitable monomers are, in accordance with the invention, vinyllactams such as N-vinylpyrrolidone or N-vinylcaprolactam, and vinyl ethers such as methylpolyethylene glycol-(350 to 3000) monovinyl ether, or those which derive from hydroxybutyl vinyl ether, such as polyethylene glycol-(500 to 5000) vinyloxybutyl ether, polyethylene glycol-block-propylene glycol-(500 to 5000) vinyloxybutyl ether, though mixed forms are of course useful in these cases too.

The pure embodiments are described in detail hereinafter:

Variant a): combination of a first crosslinker, non-hydrolysable under the conditions of its application, and of a second crosslinker, showing a hydrolysable carbonic acid ester function under the conditions of its application.

In this pure embodiment a), the retardation is achieved by a specific combination of the crosslinkers. The combination of two or more crosslinkers in a superabsorbent polymer is nothing new per se. It is discussed in detail, for example, in U.S. Pat. No. 5,837,789. In the past, the combination of crosslinkers has been used, however, in order to improve the antagonistic properties of absorption capacity and soluble fraction, and of absorption capacity and permeability. Specifically, a high absorption is promoted by small amounts of crosslinker; however, this leads to increased soluble fractions and vice versa. The combination of different crosslinkers forms, overall, better products over the three properties of absorption capacity, soluble fraction and permeability. The retardation of the swelling by several minutes by virtue of a crosslinker combination and more particularly to >10 minutes has to date been unknown. When, for example, in the area of superabsorbent polymers for nappies, a time delay is established in order that the liquid is first distributed within the nappy and then absorbed, it is typically in the region of a few seconds.

Preferably, the inventive superabsorbents of this embodiment a) are present either in the form of anionic or cationic polyelectrolytes, but essentially not as polyampholytes. Polyampholytes are understood to mean polyelectrolytes which bear both cationic and anionic charges on the polymer chain. Preference is thus given in this case to copolymers of purely anionic or purely cationic nature and not polyampholytes. However, up to 10 mol %, preferably less than 5 mol %, of the total charge of a polyelectrolyte may be replaced by components of opposite charge. This applies both in the case of predominantly anionic copolymers with a relatively small cationic component and also conversely to predominantly cationic copolymers with a relatively small anionic fraction.

Suitable monomers for anionic superabsorbent polymers are, for example, ethylenically unsaturated, water-soluble carboxylic acids and carboxylic acid derivatives or ethylenically unsaturated sulphonic acid monomers.

Preferred ethylenically unsaturated carboxylic acid or carboxylic anhydride monomers are acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, itaconic acid, citraconic acid, mesaconic acid, glutaconic acid, aconitic acid, maleic acid, fumaric acid, tricarboxyethylene and maleic anhydride, particular preference being given to acrylic acid and methacrylic acid. Ethylenically unsaturated sulphonic acid monomers are preferably aliphatic or aromatic vinylsulphonic acids or acrylic or methacrylic sulphonic acids. Preferred aliphatic or aromatic vinylsulphonic acids are vinylsulphonic acid, allylsulphonic acid, vinyltoluenesulphonic acid and styrenesulphonic acid.

Preferred acryloyl- and methacryloylsulphonic acids are sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid, particular preference being given to 2-acrylamido-2-methylpropanesulphonic acid.

All acids listed may have been polymerized as free acids or as salts. Of course, partial neutralization is also possible. In addition, some or all of the neutralization may also be effected only after the polymerization. The monomers can be neutralized with alkali metal hydroxides, alkaline earth metal hydroxides or ammonia. In addition, any further organic or inorganic base which forms a water-soluble salt with the acid is conceivable. Mixed neutralization with different bases is also conceivable. A preferred feature of this invention is neutralization with ammonia and alkali metal hydroxides, and more preferably with sodium hydroxide.

In addition, further nonionic monomers with which the number of anionic charges in the polymer chain can be adjusted may also have been used. Possible water-soluble acrylamide derivatives are alkyl-substituted acrylamides or aminoalkyl-substituted derivatives of acrylamide or of methacrylamide, for example acrylamide, methacrylamide, N-methylacrylamide, N-methylmethacrylamide, N,N-dimethylacrylamide, N-ethylacrylamide. N,N-diethylacrylamide, N-cyclohexylacrylamide, N-benzylacrylamide, N,N-dimethylaminopropylacrylamide, N,N-dimethylaminoethylacrylamide and/or N-tert-butylacrylamide. Further suitable nonionic monomers are N-vinylformamide, N-vinylacetamide, acrylonitrile and methacrylonitrile, but also vinyllactams such as N-vinylpyrrolidone or N-vinylcaprolactam, and vinyl ethers such as methylpolyethylene glycol-(350 to 3000) monovinyl ether, or those which derive from hydroxybutyl vinyl ether, such as polyethylene glycol-(500 to 5000) vinyloxybutyl ether, polyethylene glycol-block-propylene glycol-(500 to 5000) vinyloxybutyl ether, and suitable mixtures thereof.

In addition, the inventive superabsorbent polymers comprise at least two crosslinkers:

in general, a crosslinker forms a bond between two polymer chains, which leads to the superabsorbent polymers forming water-swellable but water-insoluble networks. One class of crosslinkers is that of monomers with at least two independently incorporable double bonds which lead to the formation of a network. In the context of the present invention, at least one crosslinker from the group of the crosslinkers not hydrolysable under the conditions of its application, and at least one crosslinker from the group of the crosslinkers hydrolysable under the conditions of its application, was selected. According to the invention, a non-hydrolysable crosslinker shall be understood to mean a crosslinker which, incorporated in the network, maintains its crosslinking action at all pH values; this means that under the conditions of the application (time, temperature, pH) there is nearly no hydrolysis. The linkage points of the network thus cannot be broken up by a change in the swelling medium. This contrasts with the crosslinker which under the conditions of the application is hydrolysable and which, incorporated in the network, can lose its crosslinking action through a change in the pH. One example of this is a diacrylate crosslinker which loses its crosslinking action through alkaline ester hydrolysis at a high pH.

Possible crosslinkers, not hydrolysable under the conditions of the application, are N,N′-methylenebisacrylamide, N,N′-methylenebismethacrylamide and monomers having more than one maleimide group, such as hexamethylenebismaleimide; monomers having more than one vinyl ether group, such as ethylene glycol divinyl ether, triethylene glycol divinyl ether and/or cyclohexanediol divinyl ether. It is also possible to use allylamino or allylammonium compounds having more than one allyl group, such as triallylamine and/or tetraallylammonium salts. The crosslinkers not hydrolysable under the conditions of its application also include the allyl ethers, such as tetraallyloxyethane and pentaerythritol triallyl ether.

The group of the monomers having more than one vinylaromatic group includes divinylbenzene and triallyl isocyanurate.

A preferred feature of the present invention is that, in process variant a), the used crosslinker, that is not hydrolysable under the conditions of its application, was at least one representative from the group of N,N′-methylenebisacrylamide, N,N′-methylenebismethacrylamide or monomers having at least one maleimide group, preferably hexamethylenebismaleimide, monomers having more than one vinyl ether group, preferably ethylene glycol divinyl ether, triethylene glycol divinyl ether, cyclohexanediol divinyl ether, allylamino or allylammonium compounds having more than one allyl group, preferably triallylamine or a tetraallylammonium salt such as tetraallylammonium chloride, or allyl ethers having more than one allyl group, such as tetraallyloxyethane and pentaerythritol triallyl ether, or monomers having vinylaromatic groups, preferably divinylbenzene and triallyl isocyanurate, or diamines, triamines, tetramines or higher-functionality amines, preferably ethylenediamine and diethylenetriamine.

Crosslinkers with a hydrolysable carbonic acid ester function under the conditions of its application may be: poly-(meth)acryloyl-functional monomers, such as 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethylene glycol diacrylate, ethylene glycol dimethacrylate, ethoxylated bisphenol A diacrylate, ethoxylated bisphenol A dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythritol tetraacrylate, pentaerythritol triacrylate, trimethylolpropane triacrylate, trimethylolpropane trimethacrylate, cyclopentadiene diacrylate, tris(2-hydroxyethyl) isocyanurate triacrylate and/or tris(2-hydroxyethyl) isocyanurate trimethacrylate; monomers having more than one vinyl ester or allyl ester group with corresponding carboxylic acid, such as divinyl esters of polycarboxylic acids, diallyl esters of polycarboxylic acids, triallyl terephthalate, diallyl maleate, diallyl fumarate, trivinyl trimellitate, divinyl adipate and/or diallyl succinate.

The preferred representatives of crosslinkers with a hydrolysable carbonic acid ester function under the conditions of its application and used in preparation variant a) were compounds which were selected from the group of the di-, tri- or tetra(meth)acrylates, such as 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethylene glycol diacrylate, ethylene glycol dimethacrylate, ethoxylated bisphenol A diacrylate, ethoxylated bisphenol A dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythritol tetraacrylate, pentaerythritol triacrylate, trimethylolpropane triacrylate, trimethylolpropane trimethacrylate, cyclopentadiene diacrylate, tris(2-hydroxyethyl) isocyanurate triacrylate and/or tris(2-hydroxyethyl) isocyanurate trimethacrylate, the monomers having more than one vinyl ester or allyl ester group with corresponding carboxylic acids, such as divinyl esters of polycarboxylic acids, diallyl esters of polycarboxylic acids, diallyl maleate, diallyl fumarate, trivinyl trimellitate, divinyl adipate and/or diallyl succinate, or at least one representative of the compounds having at least one vinylic or allylic double bond and at least one epoxy group, such as glycidyl acrylate, allyl glycidyl ether, or the compounds having more than one epoxy group, such as ethylene glycol diglycidyl ether, diethylene glycol diglycidyl ether, polyethylene glycol diglycidyl ether, polypropylene glycol diglycidyl ether, or the compounds having at least one vinylic or allylic double bond and at least one (meth)acrylate group, such as polyethylene glycol monoallyl ether acrylate or polyethylene glycol monoallyl ether methacrylate.

Further crosslinkers which contain functional groups both from the class of the carbonic acid ester functions hydrolysable under the conditions of the application and of the crosslinker groups not hydrolysable under the conditions of the application should be included among the class of crosslinkers that show a hydrolysable carbonic acid ester function under the conditions of the application, when they form not more than one crosslinking point not hydrolysable under the conditions of the application. Typical examples of such crosslinkers are polyethylene glycol monoallyl ether acrylate and polyethylene glycol monoallyl ether methacrylate.

In addition to the crosslinkers having two or more double bonds, there are also those which have only one or no double bond, but do have other functional groups which can react with the monomers and which lead to crosslinking points during the preparation process. Two frequently used functional groups are in particular epoxy groups and amino groups. Examples of such crosslinkers with a double bond are glycidyl acrylate, allyl glycidyl ether. Examples of crosslinkers without a double bond are diamines, triamines or compounds having four or more amino groups, such as ethylenediamine, diethylenetriamine, or diepoxides such as ethylene glycol diglycidyl ether, diethylene glycol diglycidyl ether, polyethylene glycol diglycidyl ether, polypropylene glycol diglycidyl ether.

In the preparation of the inventive superabsorbents, sufficiently high total amounts of crosslinker as to give rise to a very close-mesh network are typically used. The polymeric product thus has only a low absorption capacity after short times (>5 min; <10 min).

The amounts of the crosslinkers not hydrolysable under the conditions of the application used in process variant a) were between 0.01 and 1.0 mol %, preferably between 0.03 and 0.7 mol % and more preferably 0.05 to 0.5 mol %. Significantly higher amounts of the crosslinkers showing a hydrolysable carbonic acid ester function under the conditions of the application are required: according to the invention, 0.1 to 10.0 mol %, preferably 0.3 to 7 mol % and more preferably 0.5 to 5.0 mol % were used.

Under the use conditions preferred in accordance with the invention, the hydrolysis-labile network links formed in the course of polymerization are broken again. The absorption capacity of the inventive superabsorbent polymer is increased significantly as a result. The required amounts of the crosslinkers should, though, be adjusted to the particular application and should be determined in performance tests (for construction material systems particularly in the time-dependent slump).

Cationic superabsorbent polymers contain exclusively cationic monomers. For cationic superabsorbent polymers of embodiment a), it is possible to use all monomers with a permanent cationic charge. “Permanent” means in turn that the cationic charge remains predominantly stable in an alkaline medium; an ester quat is, for example, unsuitable. The nonionic comonomers and crosslinkers used may be all monomers listed among the anionic superabsorbent polymers, employing the abovementioned molar ratios. Possible cationic monomers are:
[3-(acryloylamino)propyl]trimethylammonium salts and/or
[3-(methacryloylamino)propyl]trimethylammonium salts. The salts mentioned are preferably present in the form of halides, sulphates or methosulphates. In addition, it is possible to use diallyldimethylammonium chloride.

The inventive anionic or cationic superabsorbent copolymers can be prepared in a manner known per se by joining the monomers which form the particular structural units by free-radical polymerization. All monomers present in acid form can be polymerized as free acids or in the salt form thereof. In addition, the acids can be neutralized by adding appropriate bases even after the copolymerization; partial neutralization before or after the polymerization is likewise possible. The monomers or the copolymers can be neutralized, for example, with the bases sodium hydroxide, potassium hydroxide, calcium hydroxide, magnesium hydroxide and/or ammonia. Likewise suitable as bases are C₁- to C₂₀-alkylamines, C₁- to C₂₀-alkanolamines, C₅- to C₈-cycloalkylamines and/or C₆- to C₁₄-arylamines, each of which has primary, secondary or tertiary and in each case branched or unbranched alkyl groups. It is possible to use one base or a plurality. Preference is given to neutralization with alkali metal hydroxides and/or ammonia; sodium hydroxide is particularly suitable. The inorganic or organic bases should be selected such that they form readily water-soluble salts with the particular acid.

For all aminic bases and ammonia, it should be checked in the application whether the alkaline medium which is formed by the pore water forms a fishy and/or ammoniacal odour, since this may possibly be a criterion for exclusion.

As likewise already mentioned in general terms, the monomers should preferably be copolymerized by free-radical bulk polymerization, solution polymerization, gel polymerization, emulsion polymerization, dispersion polymerization or suspension polymerization. Since the inventive products are hydrophilic and water-swellable copolymers, polymerization in aqueous phase, polymerization in inverse emulsion (water-in-oil) and polymerization in inverse suspension (water-in-oil) are preferred variants. In particularly preferred embodiments, the reaction is effected as a gel polymerization or else as an inverse suspension polymerization in organic solvents.

Process variant a) may also have been performed as an adiabatic polymerization, and may have been started either with a redox initiator system or with a photoinitator. However, a combination of both variants of the initiation is also possible. The redox initiator system consists of at least two components, an organic or inorganic oxidizing agent and an organic or inorganic reducing agent. Frequently, compounds with peroxide units are used, for example inorganic peroxides such as alkali metal persulphate and ammonium persulphate, alkali metal perphosphates and ammonium perphosphates, hydrogen peroxide and salts thereof (sodium peroxide, barium peroxide), or organic peroxides such as benzoyl peroxide, butyl hydroperoxide, or peracids such as peracetic acid. In addition, it is also possible to use other oxidizing agents, for example potassium permanganate, sodium chlorate and potassium chlorate, potassium dichromate, etc. The reducing agents used may be sulphur compounds such as sulphites, thiosulphates, sulphinic acid, organic thiols (for example ethyl mercaptan, 2-hydroxyethanethiol, 2-mercaptoethylammonium chloride, thioglycolic acid) and others. In addition, ascorbic acid and low-valency metal salts [copper(I); manganese(II); iron(II)] are suitable. Phosphorus compounds, for example sodium hypophosphite, can also be used. As their name suggests, photopolymerizations are started with UV light, which results in the decomposition of a photoinitiator. The photoinitiators used may, for example, be benzoin and benzoin derivatives, such as benzoin ethers, benzil and derivatives thereof, such as benzil ketals, aryldiazonium salts, azo initiators, for example 2,2′-azobis(isobutyronitrile), 2,2′-azobis(2-amidinopropane) hydrochloride and/or acetophenone derivatives. The proportion by weight of the oxidizing component and of the reducing component in the case of the redox initiator systems is preferably in each case in the range between 0.00005 and 0.5% by weight, more preferably in each case between 0.001 and 0.1% by weight. For photoinitiators, this range is preferably between 0.001 and 0.1% by weight and more preferably between 0.002 and 0.05% by weight. The percentages by weight stated for the oxidizing and reducing components and the photoinitiators are based in each case on the mass of the monomers used for the copolymerization. The polymerization conditions, especially the amounts of initiator, are always selected with the aim of obtaining very long-chain polymers. Owing to the insolubility of the crosslinked copolymers, the determination of the molecular weights is, however, possible only with great difficulty.

The copolymerization is preferably performed in aqueous solution, especially in concentrated aqueous solution, batchwise in a polymerization vessel (batchwise process) or continuously by the “endless belt” method described, for example, in U.S. Pat. No. 4,857,610. A further possibility is polymerization in a continuous or batchwise kneading reactor. The process is started typically at a temperature between −20 and 20° C., preferably between −10 and 10° C., and performed at atmospheric pressure and without external heat supply, the heat of polymerization resulting in a maximum end temperature, depending on the monomer content, of 50 to 150° C. The end of the copolymerization is generally followed by comminution of the polymer present in gel form. In the case of performance on the laboratory scale, the comminuted gel is dried in a forced-air drying cabinet at 70 to 180° C., preferably at 80 to 150° C. On the industrial scale, the drying can also be effected in a continuous manner within the same temperature ranges, for example on a belt dryer or in a fluidized bed dryer. In a further preferred embodiment, the copolymerization is effected as an inverse suspension polymerization of the aqueous monomer phase in an organic solvent. The procedure here is preferably to polymerize the monomer mixture which has been dissolved in water and optionally neutralized in the presence of an organic solvent in which the aqueous monomer phase is soluble sparingly, if at all. Preference is given to working in the presence of “water-in-oil” emulsifiers (W/O emulsifiers) and/or protective colloids based on low or high molecular weight compounds which are used in proportions of 0.05 to 5% by weight, preferably 0.1 to 3% by weight (based in each case on the monomers). The W/O emulsifiers and protective colloids are also referred to as stabilizers. It is possible to use customary compounds known as stabilizers in inverse suspension polymerization technology, such as hydroxypropylcellulose, ethylcellulose, methylcellulose, cellulose acetate butyrate mixed ethers, copolymers of ethylene and vinyl acetate, of styrene and butyl acrylate, polyoxyethylene sorbitan monooleate, monolaurate or monostearate, and block copolymers of propylene oxide and/or ethylene oxide. Suitable organic solvents are, for example, linear aliphatic hydrocarbons such as n-pentane, n-hexane, n-heptane, branched aliphatic hydrocarbons (isoparaffins), cycloaliphatic hydrocarbons such as cyclohexane and decalin, and aromatic hydrocarbons such as benzene, toluene and xylene. Further suitable solvents are alcohols, ketones, carboxylic esters, nitro compounds, halogenated hydrocarbons, ethers and many other organic solvents. Preference is given to organic solvents which form azeotropic mixtures with water, particular preference to those which have a very high water content in the azeotrope.

The water-swellable copolymers (superabsorbent precursor) are initially obtained in swollen form as finely distributed aqueous droplets in the organic suspension medium, and are preferably isolated as solid spherical particles in the organic suspension medium by removing the water by azeotropic distillation. Removal of the suspension medium and drying leaves a pulverulent solid. Inverse suspension polymerization is known to have the advantage that variation of the polymerization conditions allows the particle size distribution of the powders to be controlled. An additional process step (grinding operation) to adjust the particle size distribution can usually be avoided as a result.

The monomers and crosslinkers should be selected taking account of the particular requirements, some of them specific, of the application. For instance, in the case of high salt burdens in the construction material system, salt-stable monomer compositions should be employed, which may be based, for example, on sulphonic acid-based monomers. In this case, the final absorption is established via the monomer composition and the crosslinkers not hydrolysable under the conditions of the application, while the crosslinker showing a hydrolysable carbonic acid ester function under the conditions of the application influences the kinetics of the swelling. However, it should be taken into account that the monomer composition and the crosslinker can also have a certain influence on the kinetics, which is different from case to case and, in particular, is less marked with respect to the influence of the crosslinker showing a hydrolysable carbonic acid ester function under the conditions of the application. Both the crosslinker not hydrolysable under the conditions of the application and the crosslinker showing a hydrolysable carbonic acid ester function under the conditions of the application should, according to the invention, be incorporated homogeneously. Otherwise, for example, regions depleted of crosslinker showing a hydrolysable carbonic acid ester function under the conditions of the application would form and would therefore begin to swell rapidly, without exhibiting the desired time delay. Too high a reactivity of the crosslinker can lead to it already being consumed before the end of the polymerization, and no further crosslinker is available at the end of the polymerization. Too low a reactivity has the effect that, at the start of the polymerization, regions low in crosslinker are formed. In addition, there is always the risk that the second double bond is not incorporated fully—the crosslinking function would thus be absent. The length of the bridge between the crosslinking points may likewise have an influence on the hydrolysis kinetics. Steric hindrance can slow the hydrolysis. Overall, the selection of the composition of the superabsorbent polymer is influenced by the application (construction material system and time window for the hydrolysis). However, the present invention provides sufficient possible variations and selections, and so it is possible without any problems to select suitable crosslinkers of mentioned classes, for example in order to ensure a homogeneous network.

Variant b): combination of a permanently anionic monomer with a hydrolysable cationic monomer, suitable for the release of its cationic charge at a pH >7 by ester hydrolysis and/or a deprotonation.

In this second embodiment, the time delay of the swelling action of the SAP is achieved through a specific combination of the monomers.

The superabsorbents of this embodiment b) of the invention are present in the form of polyampholytes. Polyampholytes are understood to mean polyelectrolytes which bear both cationic and anionic charges on the polymer chain. Combination of cationic and anionic charge within the polymer chain results in formation of strong intramolecular attraction forces which lead to the absorption capacity being reduced significantly, or even approaching zero.

In embodiment b), the cationic monomers were selected such that they lose their cationic charge with time and become uncharged or even anionic. The two following reaction schemes are intended to illustrate this in detail:

In the first case, a cationic ester quat, as a polymerized constituent of the SAP, is converted in the course of application by an alkaline hydrolysis to a carboxylate.

In the second case, a cationic acrylamide derivative becomes nonionic as a result of a neutralization,

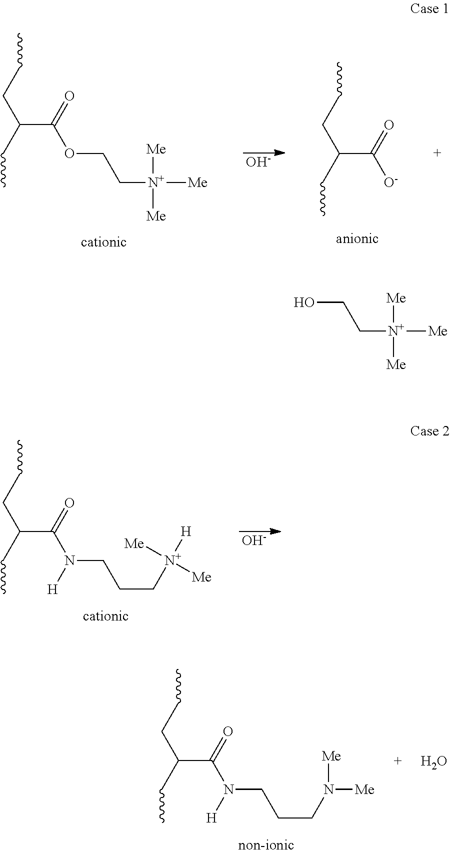

Useful anionic monomers in this process variant b) are all anionic monomers already mentioned for process variant a). Preferred representatives in accordance with the invention are considered to be those from the group of the ethylenically unsaturated water-soluble carboxylic acids and ethylenically unsaturated sulphonic acid monomers, and salts and derivatives thereof, especially acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, itaconic acid, citraconic acid, mesaconic acid, glutaconic acid, aconitic acid, maleic acid, fumaric acid, tricarboxyethylene and maleic anhydride, more preferably acrylic acid, methacrylic acid, aliphatic or aromatic vinylsulphonic acids, and especially preferably vinylsulphonic acid, allylsulphonic acid, vinyltoluenesuiphonic acid, styrenesulphonic acid, acryloyl-and methacryloylsulphonic acids, and even more preferably sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid (AMPS), or mixtures thereof.

Representatives of cationic monomers suitable for the release of its cationic charge by ester hydrolysis and/or deprotonation under the conditions of the application may be:

For Case 1 in FIG. 1: [2-(acryloyloxy)ethyl]trimethylammonium salts and [2-(methacryloyloxy)ethyl]trimethylammonium salts. In principle, all polymerizable cationic esters of vinyl compounds whose cationic charge can be eliminated by hydrolysis are conceivable.

For Case 2 in FIG. 1: salts of 3-dimethylaminopropylacrylamide or 3-dimethylaminopropylmethacrylamide, preference being given to the hydrochloride and hydrosulphate. In principle, all monomers which are vinylically polymerizable and bear an amino function which can be protonated can be used. Preferred representatives of the cationic monomers are, according to the present invention, polymerizable cationic esters of vinyl compounds whose cationic charge can be eliminated by hydrolysis, preferably [2-(acryloyloxy)ethyl]trimethylammonium salts and [2-(methacryloyloxy)ethyl]trimethylammonium salts, or monomers which are vinylically polymerizable and bear an amino function which can be protonated, preferably salts of 3-dimethylaminopropylacrylamide or 3-dimethylaminopropylmethacrylamide, and more preferably the hydrochloride and hydrosulphate thereof, or mixtures thereof.

Since the inventive SAPs prepared by process variant b) are suitable in particular for applications having a high pH, which is the case especially in cementitious systems, at least one crosslinker should be selected from the above-described group of the crosslinkers not hydrolysable under the conditions of the application.

The present invention also envisages that the SAPs can be prepared by all variants as have already been described under embodiment a).

To control the retardation, it is possible in principle to incorporate additional monomers from the group of the above-described nonionic monomers into the inventive superabsorbent polymer. The use of nonionic monomers brings about an acceleration of the increase in the absorption capacity.

For the second process variant b) of the invention too, it is important first to achieve an absorption of close to zero in demineralized water. This is achieved through the selection of the correct amounts of cationic and anionic monomers. Ideally, the minimum absorption is achieved at a molar ratio of the cationic to anionic monomers of 1:1. In the case of weak acids or bases, it may be necessary to establish a molar ratio which deviates from 1:1 (for example 1.1 to 2.0:2.0 to 1.1).

If relatively fast retarded swelling is required, a low absorption can also be established. This too is achieved by a monomer composition deviating from the ratio of 1:1 (for example 1.1 to 2.0:2.0 to 1.1). As a result of the low residual absorption, the retarded superabsorbent polymer absorbs a little water or aqueous solution in the application, and the neutralization/hydrolysis takes place more rapidly. In all cases of process variant b), the molar ratio of anionic to cationic monomer is 0.3 to 2.0:1.0, preferably 0.5 to 1.5:1.0 and more preferably 0.7 to 1.3:1.0.

A further means in principle of controlling the kinetics is the addition of salt. Polyampholytes often have an inverse electrolyte effect, i.e. the addition of salts increases the solubility in water. This salt is added to the monomer solution. In the case of gel polymerization, it may, though, also be added to the gel as an aqueous solution.

The selection of the crosslinkers likewise allows the kinetics of the swelling to be influenced. The type and the amount of crosslinker are additionally crucial for the absorption behaviour of the retarded superabsorbent polymer after the complete hydrolysis/neutralization of the cationic monomers. Again, the swelling kinetics and the final absorption should be and can be adjusted to the particular application. In this case, both the application and the raw materials of the formulation again play a major role.

A further possible variant of this embodiment is that of the so-called interpenetrating network: in this case, two networks are formed within one another. One network is formed from a polymer of cationic monomers, the second from anionic monomers. The charges should balance overall. It may be found to be favourable to additionally incorporate nonionic monomers into the network. Interpenetrating networks are prepared by initially charging a cationic (or anionic) polymer in an anionic (or cationic) monomer solution and then polymerizing. The crosslinking should be selected such that the two polymers form a network: the initially charged polymer and the newly formed polymer.

Variant c: coating with an oppositely charged solution polymer

In this third process variant c), the retardation is achieved through a specific surface treatment of the superabsorbent polymer. In this case, the charged superabsorbent polymer is coated with an oppositely charged polymer. The balancing of the charges on the polymer surface, as preferably provided by the present invention, forms a water-impermeable simplex layer which prevents swelling of the superabsorbent polymer within the first few minutes. This surface treatment should become detached from the SAP with time (at least 10 to 15 minutes!), which significantly increases the absorption capacity of the superabsorbent polymer.

The surface treatment of anionic superabsorbent polymers, preferably crosslinked, partly neutralized polyacrylic acids, with cationic polymers has already been described in a series of patents: The already cited publications WO 2006/082188 and WO 2006/082189 describe surface treatment with one to two percent of polyamine; in DE 10 2005 018922, polyDADMAC (polydiallyldimethylammonium chloride) is applied to superabsorbent polymers. In the course of polyamine coating, crosslinking components are present. This involves spraying cationic polymers as aqueous solutions onto the granular superabsorbent polymer. The superabsorbent polymers thus obtained have a higher permeability and a lower tendency to form lumps in the course of storage, i.e. remain free-flowing for longer. Since these SAPs have been developed exclusively for use in nappies, they of course must not have a time delay in the range of minutes. EP 1 393 757 A1 describes surface coating with partly hydrolysed polyvinylformamide. This leads to improved performance in the nappy. WO 2003/43670 likewise describes the crosslinking of polymers which have been applied to the surface.

Generally, in accordance with the invention, cationic polymers with a molecular weight of 5 million g/mol or less are used, which, as a 10 to 20% aqueous solution, give rise to a sprayable solution (viscosity). They are polymerized as an aqueous solution and used for surface treatment. In the standard processes, the superabsorbent polymer is initially charged, for example in a fluidized bed, and sprayed with a polymer solution. Generally, “highly cationic” polymers are used, i.e. those whose cationic monomers make up at least 75 mol % of the composition.

The present invention prefers the use of shell polymers with a molecular weight of ≦3 million g/mol, preferably ≦2 million g/mol and more preferably <1.5 million g/mol, and the selected shell polymers should have either anionic or cationic properties. Ampholytes are not used.

A further combination of cationic and anionic polyelectrolytes is that of MBIE-superabsorbent polymers, where MBIE stands for “mixed bed ion exchange”. Such products are described, inter alia, in U.S. Pat. No. 6,603,056 and the patents cited there: a potentially anionic superabsorbent polymer is mixed with a superabsorbent cationic polymer. “Potentially anionic” means that, in the embodiments of the invention, the anionic superabsorbent polymer is used in acidic form. While the purely anionic superabsorbent polymers are usually polyacrylic acids neutralized to an extent of approx. 70%, crosslinked polyacrylic acids which are neutralized only to a low degree, if at all, are used here. The combination with a cationic polymer leads to a more salt-stable product: the salts are effectively neutralized by ion exchange, as shown in FIG. 2 below. The neutralized acid then possesses the appropriate osmotic pressure (π) for significant swelling.

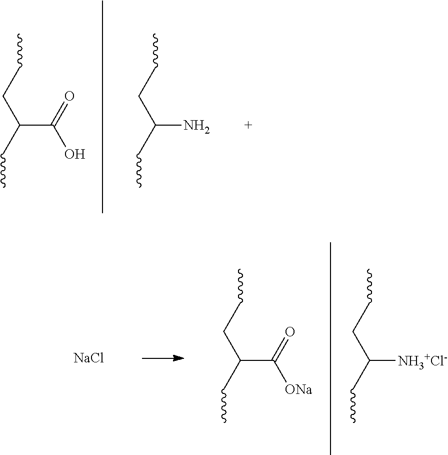

This concept for superabsorbent polymers was also developed exclusively for use in hygiene articles, specifically in nappies, and is thus again aimed at fast superabsorbent polymers. The combination of anionic and cationic superabsorbent polymer to provide a superabsorbent polymer retarded in the range of minutes has not been described to date.

The starting material used for the surface treatment in the present invention may be any superabsorbent polymer which has sufficient absorption capacity in cementitious systems in particular. It may be either anionic or cationic. The starting material shall be referred to hereinafter as “core polymer”. The polymer which is applied to the surface shall be referred to hereinafter as “shell polymer”. The core polymers are anionic or cationic superabsorbent polymers, preferably in the sense of process variant a), which have especially ≦10% by weight of comonomers with opposite charge. In contrast to variant a), the core polymers used in pure embodiment c) are, however, only superabsorbent polymers which are formed exclusively from crosslinkers not hydrolysable under the conditions of the application. This variant is considered to be preferred. Apart from the restriction for the crosslinkers, the synthesis of the anionic core polymers corresponds to that described in process variant a). For the present case too, it is possible to use all monomers already described there.

For cationic core polymers, it is possible to use all monomers with a permanent cationic charge. “Permanent” in turn means that the cationic charge is maintained in alkaline medium and thereby stable under the conditions of the application; an ester quat is thus unsuitable. Preference is given to: [3-(acryloylamino)propyl]trimethylammonium salts and [3-(methacryloylamino)propyl]trimethylammonium salts. The salts mentioned are preferably present as halides, methosulphates or sulphates. In addition, it is possible to use diallyldimethylammonium chloride.

For the treatment of the surface, two preferred processes are possible, both of which are also described in U.S. Pat. No. 6,603,056:

One process is basically a conventional powder coating. The core polymer is initially charged and set in motion, for example in a fluidized bed. Subsequently, the oppositely charged shell polymer is applied. Finally, the product is dried. This process is suitable in particular when relatively small amounts of shell polymer based on the core polymer are to be applied. In the case of larger amounts in this process, conglutination of the particles occurs and the product cakes together. This leads to the surfaces no longer being coated homogeneously. In order to apply large amounts of shell polymer, this process step has to be carried out repeatedly.

For larger amounts of shell polymer, a second process is suitable: in this process, the core polymer is suspended in an organic solvent. The shell polymer solution is added to the suspension, and then, for electrostatic reasons, the core polymer is coated with an oppositely charged shell. For very small particles too, this process is advantageous since they are difficult to handle in a fluidized bed.

After the addition of the shell polymer solution, the amount of water added through the solution can optionally be distilled off azeotropically. Therefore, preferred organic solvents are considered to be those which form an azeotrope with a maximum water content, in which the superabsorbent polymer and the shell polymer are insoluble. For this process, it is possible to use the same solvents which are also specified in process variant a) among the solvents for the suspension polymerization. It has also been found to be advantageous to add a protective colloid, as is also done in the suspension polymerization. Again, it is possible to select from the protective colloids described there.

For the surface coating, as described, a shell polymer is applied to the core polymer. The shell polymer is preferably applied as an aqueous solution and is especially used as a sprayable solution, particularly suitable solutions being those having a viscosity of from 200 to 7500 mPas. Working with organic solvents is very complicated in this process, particularly on the industrial scale. For both processes just described, it is favourable to work with low-viscosity solutions since they can be sprayed better and also become attached more readily to the surface of the suspended core polymer.

Since the molecular weight of the shell polymer has a significant influence on the viscosity, shell polymers with a molecular weight of less than 5 million g/mol are preferred. Moreover, it is envisaged in accordance with the invention that the further polyelectrolyte, i.e. the shell polymer, has a proportion of cationic monomer of ≧75 mol %, preferably ≧80 mol % and more preferably between 80 and 100 mol %.

In principle, it is possible to prepare such cationic or anionic shell polymers either by the process of gel polymerization or by that of suspension polymerization, and then to redissolve the resulting polymers and to apply them as an aqueous shell polymerization solution. However, it is more advantageous to perform the polymerization as a solution polymerization, such that the product of the polymerization can be used directly and no more than a dilution is still necessary. The molecular weight of the shell polymers can be reduced by the addition of chain regulators, which allows the desired chain length and hence also the desired viscosity to be obtained.

The procedure is preferably as follows:

The monomers are dissolved in water or their commercially obtainable aqueous solutions are diluted. Then the chain regulator(s) is/are added and the pH is adjusted. Subsequently, the aqueous monomer solution is inertized with nitrogen and heated to the start temperature. With the addition of the initiators, the polymerization is started and proceeds generally within a few minutes. The concentration of the shell polymer is selected at a maximum level in order that the amount of water to be removed is at a minimum, but the viscosity can still be handled readily in the processes according to the invention, such as spraying, coating in suspension. It may be advantageous to heat the shell polymer solution since the viscosity at the same concentration falls at higher temperatures. Suitable chain regulators are formic acid or salts thereof, for example sodium formate, hydrogen peroxide, compounds which comprise a mercapto group (R—SH) or a mercaptate group (R—S-M+), where the R radical here may in each case be an organic aliphatic or aromatic radical having 1 to 16 carbon atoms (for example mercaptoethanol, 2-mercaptoethylamine, 2-mercaptoethylammonium chloride, thioglycolic acid, mercaptoethanesulphonate (sodium salt), cysteine, trismercaptotriazole (TMT) as the sodium salt, 3-mercaptotriazole, 2-mercapto-1-methylimidazole), compounds which comprise an R—S—S—R′ group (disulphite group), where the R and R′ radicals here may each independently be an organic aliphatic or aromatic radical having 1 to 16 carbon atoms (for example cystaminium dichloride, cysteine), phosphorus compounds, such as hypophosphorous acid and salts thereof (e.g. sodium hypophosphite), or sulphur-containing inorganic salts such as sodium sulphite.

Possible shell polymers for anionic core polymers are cationic polymers which can lose their cationic charge through a chemical reaction. Possible cationic monomers for this embodiment are ester quats, for example [2-(acryloyloxy)ethyl]trimethylammonium salts, [2-(methacryloyloxy)ethyl]trimethylammonium salts, dimethylaminoethyl methacrylate quaternized with diethyl sulphate or dimethyl sulphate, diethylaminoethyl acrylate quaternized with methyl chloride. In this case, the chemical reaction which leads to retarded swelling of the SAP is an ester hydrolysis. A neutralization reaction of the shell polymer is possible with the following polymers: poly-3-dimethylaminopro-pylacrylamide, poly-3-dimethylaminopropylmethacrylamide, polyallylamine, polyvinylamine, polyethyleneimine. All polymers are used here in the form of salts. For the neutralization of the amino function, inorganic or organic acids can be used, and their mixed salts are also suitable. All variants mentioned are encompassed by the present invention.

For the establishment of the kinetics of the detachment reaction which are appropriate for the application, it may be necessary to incorporate further nonionic monomers into the cationic shell polymer. It is possible to use all nonionic monomers already mentioned under process variant a).

This variant c) of the invention is not just restricted to one-layer shells. In order to achieve a further or more exact time delay, it is possible, after the first shell layer which has been applied directly to the core polymer, to apply a second with the same charge that the core polymer also originally possesses. This can be continued further, in which case the charges of the shell polymers alternate. An anionic core polymer would be followed after the first cationic shell by an anionic second shell. The third shell would then be cationic again. Irrespective of the number of different shell layers, one or more shell layer(s) may be crosslinked. Moreover, preferably at least one shell layer should have been crosslinked with the aid of an aqueous solution.

Moreover, the present invention takes account of the possibility that the shell polymer in process variant c), per layer applied, was used in an amount of 5 to 100% by weight, preferably of 10 to 80% by weight and more preferably in an amount of 25 to 75% by weight, based in each case on the core polymer.

A further variation of the invention relates to the crosslinking of the shell polymer and the control of its detachment rate. To this end, it is possible, for example, to use free amino groups of the shell polymers. The crosslinker is added later than the shell polymer, preferably as an aqueous solution. In order to ensure full reaction of the crosslinker, it may be necessary to heat the retarded superabsorbent polymer once again after drying, or to perform the drying at elevated temperature. Possible crosslinkers for this form of the procedure are diepoxides such as diethylene glycol diglycidyl ether or polyethylene glycol diglycidyl ether, diisocyanates (which have to be applied in anhydrous form after the drying), glyoxal, glyoxylic acid, formaldehyde, formaldehyde formers and suitable mixtures.

In order to control the kinetics of the detachment operation, the composition of the shell polymer should be adjusted to the core polymer. This can be done, for example, by determining the appropriate composition. It has been found to be favourable to establish identical molar ratios in the core polymer and in the shell polymer; however, the charges must be different. According to the application, however, deviations from the molar ratios may also be found to be positive.

The optimal amount of shell polymer likewise has to be determined. Generally, it can be stated that finely structured core polymers require larger amounts of shell polymer, since they possess a greater surface area. The molecular weight of the shell polymers may also play a role, since short-chain shell polymers become detached more readily. The process of surface coating c) requires more process steps than the two alternative steps a) and b). In principle, it is also conceivable to perform the core polymer synthesis as an inverse suspension polymerization and, after the drying by azeotropic distillation, to supply a new monomer solution which corresponds to that of the shell polymer. Were this to be surface polymerized, process variant c) would be reduced to a one-pot reaction. However, the residence time in the reactor would be quite long and it is not easy to form a homogeneous layer of the shell polymer only at the surface.

Variant d: combination of a first monomer, not hydrolysable under the conditions of the application, with a second monomer showing a hydrolysable carbonic acid ester function under the conditions of the application, in the presence of a crosslinker.

The further process variant d) of the invention relates to an SAP which, after the polymerization, is composed of at least two nonionic comonomers but contains not more than 5 mol % of anionic or cationic charge. Among these nonionic comonomers is at least one which can be converted by a chemical reaction, preferably a hydrolysis, to an ionic monomer which is defined in the following as monomer showing a hydrolysable carbonic acid ester function under the conditions of the application. The remainder consists of permanently nonionic monomers which are not subject to any significant hydrolysis under the conditions of the application even in the case of prolonged treatment of the SAP at high pH. This monomer which is then ionic gives rise to an osmotic pressure which leads to greater swelling of the SAP. An example given is that of an SAP which consists of acrylamide and hydroxypropyl acrylate (HPA), and also a crosslinker. When this SAP is exposed to an alkaline medium, an ester hydrolysis of the HPA occurs, which leads to acrylate units. This gives rise to an additional osmotic pressure and the SAP swells further. In this embodiment, it should be noted that purely nonionic SAP also has a certain “natural” swelling (entropy effect, comparable to an EPDM rubber in petroleum); there is therefore not zero swelling here in the initial stage.

The polymerization is performed as already described in embodiment a).

Suitable monomers not hydrolysable under the conditions of the application are preferably permanently nonionic monomers which are preferably selected from the group of the water-soluble acrylamide derivatives, preferably alkyl-substituted acrylamides or aminoalkyl-substituted derivatives of acrylamide or of methacrylamide, and more preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide, N-tert-butylacrylamide, N-vinylformamide, N-vinylacetamide, acrylonitrile, methacrylonitrile, or any mixtures thereof.

Suitable monomers showing a hydrolysable carbonic acid ester function under the conditions of the application are selected from nonionic monomers, for example water-soluble or water-dispersible esters of acrylic acid or methacrylic acid, such as hydroxyethyl (meth)acrylate, hydroxypropyl (meth)acrylate (as a technical grade product, an isomer mixture), esters of acrylic acid and methacrylic acid which possess, as a side chain, polyethylene glycol, polypropylene glycol or copolymers of ethylene glycol and propylene glycol, and ethyl (meth)acrylate, methyl (meth)acrylate, 2-ethylhexyl acrylate.

In addition, it is possible to use amino esters of acrylic or methacrylic acid, since these too are deprotonated very rapidly in cementitious systems (high pH) and hence are present in neutral form. Possible monomers of this type are dimethylaminoethyl (meth)acrylate, tert-butylaminoethyl methacrylate or diethylaminoethyl acrylate. Useful crosslinkers include especially all representatives either hydrolysable or not hydrolysable under the conditions of the application already specified in connection with process variant a), which can also be used in this case a) in the proportions specified there in each case.

In the case of variant d), the pure embodiment shall be understood to be that in which exclusively crosslinkers not hydrolysable under the conditions of the application are used.

Mixed embodiments:

Finally, the invention includes any desired combinations of the four process variants a), b), c) and d): in many cases, it is advisable to combine the different variants (a+b+c+d; a+b+c; a+b+d; b+c+d; a+c+d; a+b; a+c; a+d; b+d; c+d). One possibility is in particular the step of gel polymerization or inverse suspension polymerization. A further aspect of the present invention can therefore be considered to be that of an SAP which has been prepared with the aid of at least two process variants a), b), c) and d) and preferably employing gel polymerization and/or an inverse suspension polymerization. It is easily also possible for a crosslinker showing a hydrolysable carbonic acid ester function under the conditions of the application to be introduced into a monomer solution composed of an anionic monomer and a cationic, monomer that can release its cationic charge at a pH >7 by ester hydrolysis and/or deprotonation, in addition to the crosslinker not hydrolysable under the conditions of the application. When such a polymer is used as a core polymer for the surface coating, the three variants a), b) and c) are implemented in the preparation of the inventive SAP.

Among all embodiments, variants a), b) and c), and the combination of variants a), b) and d), are preferred, since they need only one process step (gel polymerization or inverse suspension polymerization), while embodiments which make use of variant c) require three process steps (synthesis of the core polymer, synthesis of the shell polymer, surface coating) or lead to prolonged residence times in the reactor.

With all process variants described, it is possible to prepare superabsorbent polymers with anionic and/or cationic properties and a retarded swelling action, which have defined particle sizes. Since, in the context of the present invention, the SAPs are introduced into different pores and fissures of the underground formations, it would be disadvantageous in accordance with the invention only to use SAPs with a specific particle size. The present invention therefore also encompasses a further process variant in which the SAP has a particle size of 0.5 to 1000 μm, preferably of 1.0 to 200 μm and more preferably of 10 to 100 μm. The particle sizes mentioned can be varied with respect to one another and combined as desired.

A main aspect relates to the retarded swelling of the inventive SAPs, which has already been described in detail. In this connection, the present invention includes a specific process variant in which, 30 min after provision of the construction chemical mixture including the inventive SAPs, not more than 70%, preferably not more than 60% and more preferably not more than 50% of the maximum absorption capacity of the superabsorbent polymer has been attained. In the context of the present invention, this maximum absorption capacity is determined in an aqueous salt solution which contains 4.0 g of sodium hydroxide or 56.0 g of sodium chloride per litre of water.

Overall, it can be stated in summary that the main subject of the present invention consists in the specific use of superabsorbent polymers, which are defined by specific preparation processes and combinations thereof, and which feature, more particularly, a retarded swelling action with a commencement of swelling no earlier than after 5 minutes. The swelling behaviour differs from the superabsorbent polymers known to date principally in that the liquid absorption, by virtue of the specific structure of the SAP, occurs with a time delay in the region of minutes. This is in contrast to the known applications in the hygiene sector, where a specific value is placed on the fact that (body) fluids are absorbed completely by the polymer within a very short time. By virtue of the retarded swelling and absorptive action of the inventive superabsorbent polymers, it is thus possible to control the time of blocking of permeable formations in the exploration and exploitation of underground mineral oil and/or natural gas deposits, and also to adjust the amount of flooding medium required to the particular specific application.

The examples which follow illustrate the advantages of the present invention without restricting it thereto.

### EXAMPLES

Abbreviations:

MADAMEQUAT=[2-(methacryloyloxy)ethyl]trimethylammonium chloride

TEPA=tetraethylenepentamine

DIMAPAQUAT=[3-(acryloylamino)propyl]trimethylammonium chloride

DEGDA=diethylene glycol diacrylate

Polymers with the following composition were synthesized:

Polymer 1 (coating of an anionic superabsorbent polymer with a cationic shell polymer)

A 2 l jacketed reactor was initially charged with 1000 g of cyclohexane. After the addition of 6 g of Span 60 protective colloid, 100 g of finely ground acrylamideiacrylic acid copolymer (Luquasorb AF 2 from BASF SE) were added and suspended. After heating to 70° C., 250 g of a 10% shell polymer solution, which is a 1:1 copolymer of acrylamide and MADAMEQUAT, were slowly added dropwise and the temperature was increased to such an extent that the water added was removable by azeotropic distillation. Once the azeotrope temperature had reached 72° C., the mixture was cooled below the boiling temperature. After the slow addition of a further 250 g of shell polymer solution, the mixture was heated again to boiling and water was separated out until the azeotrope temperature was 75° C.

After cooling, the mixture was filtered and washed with a little ethanol.

The shell polymer was prepared as follows:

A 10 l jacketed reactor was initially charged with 1.6 kg of water. Then 200.4 g of acrylamide (50% solution in water) and 133.4 g of MADAMEQUAT were added, and 20% NaOH was used to establish a pH of 5. Subsequently, 38 g of water were added and the solution was purged with N₂ for 30 min. During the purging, the reaction mixture was heated to 60° C. The polymerization is initiated by adding 380 ppm of TEPA and 2000 ppm of sodium peroxodisulphate. The mixture was polymerized at 60° C. for 2 h, cooled and transferred.

Polymer 2

A 2 l three-neck flask with stirrer and thermometer was initially charged with 99 g of water and then 186.1 g of Na-AMPS (50% aqueous solution), 140.2 g of DIMAPAQUAT, 216.9 g of acrylamide (50% aqueous solution), 13.8 g of DEGDA and 14.3 g of methylenebisacrylamide (2%) were added successively. After the addition of a further 89 g of water, adjustment to pH 5 with 20% H₂SO₄ and purging with N₂ for 30 min, the mixture was cooled to 10° C.

The solution was then transferred into a plastic container with the dimensions (w×d×h) 15 cm×10 cm×20 cm, and then 200 ppm of 2,2′-azobis(2-amidinopropane) dihydrochloride, 250 ppm of sodium peroxodisulphate, 8 ppm of sodium bisulphite, 20 ppm of tert-butyl hydroperoxide and 3 ppm of iron(II) sulphate heptahydrate were metered in successively. The polymerization was initiated by irradiating with UV light (Cleo Performance 40 W).

After approx. 2 h, the resulting gel was taken from the plastic container and cut into cubes of edge length approx. 5 cm with scissors. Before the gel cubes were comminuted by means of a conventional meat grinder, they were painted with the separating agent coconut fatty acid diethanolamide.

The resulting gel granule was distributed uniformly on drying grids and dried to constant weight (approx. 3 h) in a forced-air drying cabinet at approx. 120° C. Approx. 300 g of a white, hard granule were obtained, which were converted to a pulverulent state with the aid of a centrifugal mill. The mean particle diameter of the polymer powder was from 30 to 50 μm and the proportion of particles which do not pass through a screen of mesh size 63 μm was less than 2%.

The time-dependent swelling behaviour of these polymers was evaluated in a synthetic high-salinity deposit water from the north German plain. The results are compiled in the table which follows:

| | Water | Water | Water | Water |
|---|---|---|---|---|
| | absorption | absorption | absorption | absorption |
| | after 1 h | after 6 h | after 24 h | after 48 h |
| | [g of water/g | [g of water/g | [g of water/g | [g of water/g |
| | of polymer] | of polymer] | of polymer] | of polymer] |
| Polymer | 2.2 | 2.4 | 2.5 | 18.7 |
| 1 | | | | |
| Polymer | 7.0 | 9.4 | 11.0 | 13.5 |
| 2 | | | | |

As can be seen from the examples, the appropriate structure of the superabsorbents allows the commencement of water absorption and of swelling to be controlled. For example, swelling commences at a relatively late stage in the case of polymer 1, whereas polymer 2 has already reached about half of its water absorption capacity after 1 h.

1-46. (canceled)

47. A process for blocking underground formations in the extraction of fossil oil or gas, comprising:
a first step of involving introducing water-absorbing particles into liquid-bearing and porous rock formations, wherein said particles are water-swellable, crosslinked and water-insoluble polymers, wherein said particles in the water-bearing rock formation finally prevent liquid flow through the rock layers by water absorption,
wherein the absorbing particles comprise a superabsorbent polymer with at least one of anionic or cationic properties and a retarded swelling action.

48. A process according to claim 47, wherein the superabsorbent polymer is prepared by polymerizing an ethylenically unsaturated vinyl compounds.

49. A process according to claim 47, wherein the process is performed in salt-containing formation waters.

50. A process according to claim 47, wherein the swelling of the superabsorbent polymer begins no earlier than after 5 minutes and it has been prepared with the aid of at least one process variant selected from the group of
a) polymerizing the monomer components in the presence of a combination comprising at least one crosslinker not hydrolyzable under the conditions of the application and at least one crosslinker showing a carbonic acid ester function hydrolyzable under the conditions of the application
b) polymerizing at least one permanently anionic monomer and at least one cationic monomer that can release its cationic charge by at least one of ester hydrolysis or deprotonation under the conditions of the application
c) coating a core polymer component with at least one further polyelectrolyte as a shell polymer
d) polymerizing at least one first monomer not hydrolyzable under the conditions of the application with at least one second monomer showing a carbonic acid ester function hydrolyzable under the conditions of the application in the presence of at least one crosslinker.

51. A process according to claim 50, wherein the monomer units of the superabsorbent polymer have been used as free acids, as a salt or in a mixed form thereof.

52. A process according to claim 50, wherein the acid components of the superabsorbent polymer are neutralized with a neutralizing agent after the polymerization.

53. A process according to claim 52, wherein the neutralizing agent is at least one member selected from the group consisting of sodium hydroxide, potassium hydroxide, calcium hydroxide, magnesium hydroxide, sodium carbonate, potassium carbonate, calcium carbonate, magnesium carbonate, ammonia, a primary C₁₋₂₀ alkylamine, a secondary C₁₋₂₀ alkylamine, a tertiary a C₁₋₂₀ alkylamine, a C₁₋₂₀ alkanolamine, a C₅₋₈ cycloalkylamine and a C₆₋₁₄ arylamine.

54. A process according to claim 52, wherein at least one of the primary C₁₋₂₀ alkylamine, the secondary C₁₋₂₀ alkylamine, the tertiary a C₁₋₂₀ alkylamine, the C₁₋₂₀ alkanolamine, the C₅₋₈ cycloalkylamine and the C₆₋₁₄ arylamine comprises at least one of a branched alkyl group or an unbranched alkyl group.

55. A process according to claim 50, wherein the polymerization in at least one of process variants a) or b) has been performed as a free-radical, bulk, solution, gel, emulsion, dispersion or suspension polymerization.

56. A process according to claim 50, wherein the polymerization has been performed under adiabatic conditions, the reaction preferably having been initiated with a redox initiator and/or a photoinitiator.

57. A process according to claim 50, wherein the polymerization has been initiated at a temperature between −20° and +60° C.

58. A process according to claim 50, wherein the polymerization has been performed under atmospheric pressure.

59. A process according to claim 50, wherein the polymerization is performed in the presence of at least one water-immiscible solvent.

60. A process according to claim 59, wherein the at least one water-immiscible solvent is an organic solvent selected from the group consisting of a linear aliphatic hydrocarbon, a cycloaliphatic hydrocarbon, an aromatic hydrocarbon, an alcohol, a ketone, a carboxylic ester, a nitro compound, a halogenated hydrocarbon and an ether.

61. A process according to claim 58, wherein the at least one water-immiscible solvent is an organic solvent that forms azeotropic mixtures with water.

62. A process according to claim 59, wherein the at least one water-immiscible solvent is selected from the group consisting of n-pentane, n-hexane, n-heptane, an isoparaffin, cyclohexane, decalin, benzene, toluene and xylene.

63. A process according to claim 48, wherein the ethylenically unsaturated vinyl compound is at least one member selected from the group consisting of an ethylenically unsaturated, water-soluble carboxylic acid, an ethylenically unsaturated sulphonic acid monomer, and salts thereof.

64. A process according to claim 48, wherein the ethylenically unsaturated vinyl compound is at least one member selected from the group consisting of acrylic acid, methacrylic acid, ethacrylic acid, α-chloroacrylic acid, α-cyanoacrylic acid, β-methylacrylic acid, α-phenylacrylic acid, β-acryloyloxypropionic acid, sorbic acid, α-chlorosorbic acid, 2′-methylisocrotonic acid, cinnamic acid, p-chlorocinnamic acid, itaconic acid, citraconic acid, mesaconic acid, glutaconic acid, aconitic acid, maleic acid, fumaric acid, tricarboxyethylene and maleic anhydride.

65. A process according to claim 48, wherein the superabsorbent polymer is an acryloylsulphonic acid or a methacryloylsulphonic acid comprising at least one representative selected from the group consisting of sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid.

66. A process according to claim 48, wherein the superabsorbent polymer is a nonionic monomer comprising at least one representative from the group of (meth)acrylamide, a water-soluble (meth)acrylamide derivative

67. A process according to claim 48, wherein the superabsorbent polymer comprises at least one member selected from the group consisting of acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide, N-tert-butylacrylamide, N-vinylformamide, N-vinylacetamide, acrylonitrile and methacrylonitrile.

68. A process according to claim 50, wherein the crosslinker not hydrolyzable under the conditions of the application and used in process variant a) is at least one representative selected from the group consisting of N,N′-methylenebisacrylamide, N,N′-methylenebismethacrylamide, a monomer with at least one maleimide group, a monomer with more than one vinyl ether group, a cyclohexanediol divinyl ether, an allylamino compound with more than one allyl group, an allylammonium compound with more than one allyl group, preferably triallylamine or a tetraallylammonium salt, an allyl ether with more than one allyl group, a monomer with vinylaromatic groups, or an ethylene amine.

69. A process according to claim 50, wherein the crosslinker showing a carbonic acid ester function hydrolyzable under the conditions of the application and used was at least one representative from the group of the di-, tri- or tetra(meth)acrylates, such as 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethylene glycol dimethacrylate, ethoxylated bisphenol A diacrylate, ethoxylated bisphenol A dimethacrylate, ethylene glycol dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dirnethacrylate, dipentaerythrityl pentaacrylate, pentaerythrityl tetraacrylate, pentaerythrityl triacrylate, trimethylolpropane triacrylate, trimethylolpropane trimethacrylate, cyclopentadienyl diacrylate, tris(2-hydroxyethyl) isocyanurate triacrylate and/or tris(2-hydroxyethyl) isocyanurate trimethacrylate, of the monomers having more than one vinyl ester or allyl ester group with corresponding carboxylic acids such as divinyl esters of polycarboxylic acids, diallyl esters of polycarboxylic acids, diallyl maleate, diallyl fumarate, trivinyl trimellitate, divinyl adipate and/or diallyl succinate, or at least one representative of the compounds with at least one vinylic or allylic double bond and at least one epoxy group, such as glycidyl acrylate, allyl glycidyl ether or the compounds having more than one epoxy group, such as ethylene glycol diglycidyl ether, diethylene glycol diglycidyl ether, polyethylene glycol diglycidyl ether, polypropylene glycol diglycidyl ether or the compounds with at least one vinylic or allylic double bond and at least one (meth)acrylate group, such as polyethylene glycol monoallyl ether acrylate or polyethylene glycol monoallyl ether methacrylate.

70. A process according to claim 50, wherein the crosslinker is present in process variant a) in an amount of from 01 to 1.0 mol %.

71. A process according to claim 50, wherein the crosslinker showing a carbonic acid ester function is present in process variant a) in an amount of from 0.1 to 10.

72. A process according to claim 50, wherein the anionic monomer used in process variant b) is at least one representative selected from the group consisting of an ethylenically unsaturated water-soluble carboxylic acid, an ethylenically unsaturated sulphonic acid monomer

73. The process according to claim 50, wherein the anionic monomer used in process variant b) is at least one representative selected from the group consisting of acrylic acid, methacrylic acid, ethacrylic acid, α-chloroacrylic acid, α-cyanoacrylic acid, β-methylacrylic acid, α-phenyl acrylic acid, β-acryloyloxypropionic acid, sorbic acid, α-chlorosorbic acid, 2′-methylisocrotonic acid, cinnamic acid, p-chlorocinnamic acid, β-stearic acid, itaconic acid, citraconic acid, mesaconic acid, glutaconic acid, aconitic acid, maleic acid, fumaric acid, tricarboxyethylene, maleic anhydride, more preferably acrylic acid, methacrylic acid, aliphatic or aromatic vinylsulphonic acids and especially preferably vinylsulphonic acid, allylsulphonic acid, yin yltoluenesulphonic acid, styrenesulphonic acid, acryloylsulphionc acid, methacryloylsulphonic acid.

74. A process according to claim 50, wherein the cationic monomer in process variant b) is at least one representative selected from the group consisting of a polymerizable cationic ester of vinyl compounds whose cationic charge can be eliminated by hydrolysis.

75. A process according to claim 50, wherein the cationic monomer in process variant b) is at least one representative selected from the group consisting of [2-(acryloyloxy)ethyl]trimethylammonium salts, [2-(methacryloyloxy)ethyl]trimethylammonium salts, a salt of 3-dimethylaminopropyl-acrylamide and a salt of 3-dimethylarninopropylmethacrylamide.

76. A process according to claim 50, wherein a molar ratio of anionic to cationic monomer, that can release its cationic charge by at least one of ester hydrolysis and deprotonation under the conditions of the application, of 0.3 to 2.0:1.0.

77. A process according to claim 50, wherein process variant c) neutralized charges on the polymer surface.

78. A process according to claim 50, wherein, in process variant c) shell polymers with a molecular weight of ≦5 million g/mol are used.

79. A process according to claim 50, wherein, in process variant c) the further polyelectrolyte (shell polymer) was used as an aqueous solution.

80. A process according to claim 50, wherein, in process variant c) the further polyelectrolyte had a proportion of cationic monomer of ≧75 mol %,.

81. A process according to claim 50, wherein, in process variant c) the core polymer had a proportion of ≦10% by weight of comonomers of opposite charge.

82. A process according to claim 50, wherein, in process variant c) a core polymer whose crosslinkers were exclusively not hydrolyzable under the conditions of the application crosslinkers was used.

83. A process according to claim 50, wherein, in process variant c) a cationic core polymer which preferably has a permanent cationic charge was used, preferably a [3-(acryloylamino)propyl]trimethylammonium salt and [3-(methacryloylamino)propyl]trimethylammonium salt and more preferably salts of the halide or methosulphate type, or else diallyldimethylammonium chloride, or a mixture thereof.

84. process according to claim 50, wherein process variant c) involves a powder coating or an electrically stable coating in suspension.

85. A process according to claim 50, wherein the shell polymers used in process variant c) have been prepared with the aid of a solution polymerization.

86. A process according to claim 50, wherein the shell polymer was used in process variant c), per layer applied, in an amount of 5 to 100% by weight on the core polymer.

87. A process according to claim 50, wherein, in process variant c) a shell polymer which, as a cationic monomer, contains at least one compound selected from the group consisting a [2-(acryloyloxy)ethyl]trimethylammonium salt, a [2-(methacryloyloxy)ethyl]trimethylammonium salt, and a [2-(acryloyloxy)ethyl]diethylmethyl ammonium salt.

88. A process according to claim 50, wherein the shell polymer in process variant c) contains at least one of the monomers from the group of 3-dimethylaminopropylacrylamide, 3-dimethylaminopropylmethacrylamide, allylamine, vinylamine or ethyleneimine.

89. A process according to claim 50, wherein the superabsorbent polymer used in process variant c) possesses at least two shell layers, the charge of the successive layers in each case being different from the layer below.

90. A process according to claim 50, wherein at least one shell layer in process variant c) is crosslinked.

91. A process according to claim 90, wherein the superabsorbent polymer used in process variant c) has at least one shell layer which has been crosslinked with the aid of an aqueous solution.

92. A process according to claim 90, wherein the at least one shell layer in process variant c) has been crosslinked with a compound selected from the group consisting of a diepoxides, and anhydrous diisocyanate, glyoxal, glyoxylic acid, formaldehyde and a formaldehyde former.

93. A process according to claim 50, wherein the monomer not hydrolyzable under the conditions of the application and used in process variant d) was a permanently nonionic monomer selected from the group consisting of a water-soluble acrylamide derivatives, preferably alkyl-substituted acrylamides or aminoalkyl-substituted derivatives of acrylamide or of methacrylamide and more preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dirnethylaminopropylacrylamide, N,N-dimethylaminoethylacrylamide, N-tert-butyl acrylamide, and also N-vinylformamide, N-vinylacetamide, acrylonitrile, methacrylonitrile, or any mixtures thereof, or else the vinyllactams such as N-vinylpyrrolidone or N-vinylcaprolactam and vinyl ethers such as methyl polyethylene glycol-(350 to 3000) monovinyl ether, or those which derive from hydroxybutyl vinyl ether, such as polyethylene glycol-(500 to 5000) vinyloxybutyl ether, polyethylene glycol-block-propylene glycol-(500 to 5000) vinyloxybutyl ether, or any mixtures thereof.

94. A process according to claim 50, wherein the monomer showing a carbonic acid ester function hydrolyzable under the conditions of the application and used in process variant d) was a nonionic monomer selected from the group of water-soluble or water-dispersible esters of acrylic acid or methacrylic acid, such as hydroxyethyl (meth)acrylate, hydroxypropyl (meth)acrylate (as a technical grade product, an isomer mixture), esters of acrylic acid and methacrylic acid which possess, as a side chain, polyethylene glycol, polypropylene glycol or copolymers of ethylene glycol and propylene glycol, ethyl (meth)acrylate, methyl (meth)acrylate and 2-ethylhexyl acrylate.

95. A process according to claim 50, wherein the superabsorbent polymer preparable by process variant d) is a nonionic monomer with a proportion of ionic charge of not more than 5.0 mol % and preferably 1.5 to 4.0 mol %.

96. A process according to claim 50, wherein the crosslinker used in process variant d) is a crosslinker not hydrolyzable under the conditions of the application and preferably at least one representative selected from the gioup of N,N′-methylenebisacrylamide, N,N′-methylenebismethacrylamide or monomers with at least one maleimide group, preferably hexamethylenebismaleimide, monomers with more than one vinyl ether group, preferably ethylene glycol divinyl ether, triethylene glycol divinyl ether, cyclohexanediol divinyl ether, allylamino or allylammonium compounds with more than one allyl group, preferably triallylamine or a tetraallylammonium salt such as tetraallylammonium chloride, or allyl ethers with more than one allyl group, such as tetraallyloxyethane and pentaerythrityl triallyl ether, or monomers with vinylaromatic groups, preferably divinylbenzene and triallyl isocyanurate, or diamines, triamines, tetramines or higher-functionality amines, preferably ethylenediamine and diethylenetriamine.

97. A process according to claim 50, wherein the crosslinker not hydrolyzable under the conditions of the application was used in process variant d) in amounts of 0. (new)01 to 1.0 mol %, preferably of 0. (new)03 to 0. (new)7 mol % and more preferably of 0. (new)05 to 0. (new)5 mol %.

98. A process according to claim 50, wherein the superabsorbent polymer used was prepared with the aid of at least two process variants a), b), c) or d) and preferably employing a gel polymerization and/or an inverse suspension polymerization.

99. A process according to claim 50 wherein process variants a) and b) were combined.

100. A process according to claim 47, wherein not more than 70%, preferably of the maximum absorption capacity of the superabsorbent polymer has been attained 30 minutes after the superabsorbent polymer has been sunk into the underground formation.

101. A process according to claim 47, wherein the superabsorbent polymer has a particle size of 0.5 to 1000 μm.
